(19) United States
(12) Patent Application Publication
(10) Pub. No.: US 2014/0075305 A1
(43) Pub. Date: Mar. 13, 2014

(54) METHOD AND APPARATUS FOR DEFINING AND RESPONDING TO HELP REQUEST IN VIRTUAL ENVIRONMENT SERVICE

(71) Applicants: Heini Kaihu, Espoo (FI); Markus Kiukkonen, Helsinki (FI); Inka Vikman, Helsinki (FI)

(72) Inventors: Heini Kaihu, Espoo (FI); Markus Kiukkonen, Helsinki (FI); Inka Vikman, Helsinki (FI)

(73) Assignee: SULAKE CORPORATION OY, Helsinki (FI)

(21) Appl. No.: 13/609,193

(22) Filed: Sep. 10, 2012

(51) Int. Cl. G06F 3/01

(52) U.S. Cl. 715/706

(57) ABSTRACT

A method includes providing a virtual environment service, wherein a plurality of characters interacting with each other; providing a first user, with a first user account associated with a first user level of the virtual environment service; providing a second user, with a second user account associated with a second user level of the virtual environment service, the second user level being higher than the first user level. The method further includes defining a help request relating to the virtual environment service, by the first user; allocating the help request to the second user; responding to the help request by the second user; generating feedback by the first user in response to the responding; and modifying the second user level based on the feedback.

### TECHNICAL FIELD

The present application generally relates to a method and an apparatus for responding to help requests in virtual environment service. The present application further relates to a method and an apparatus for providing feedback to a user based on the responding and amending user access level based on the feedback.

### BACKGROUND ART

Virtual environments that are accessible to a plurality of users via a server are well known. For example, hundreds of thousands of players access massive multi player online games and online auctions. Often, though not necessarily, virtual environment services have no ultimate “winner” or “winning goal” but instead attempt to create an enjoyable playing environment and a strong player community.

It would be advantageous to provide improved methods and apparatus for increasing the enjoyment and/or longevity of virtual environment services.

### SUMMARY

According to a first example aspect of the invention there is provided a method comprising:

providing a virtual environment service, wherein a plurality of characters interacting with each other;

providing a first user, with a first user account associated with a first user level of the virtual environment service;

providing a second user, with a second user account associated with a second user level of the virtual environment service, the second user level being higher than the first user level;

defining a help request relating to the virtual environment service, by the first user;

allocating the help request to the second user;

responding to the help request by the second user;

generating feedback by the first user in response to the responding; and

modifying the second user level based on the feedback.

In an embodiment, the method further comprising:

providing a plurality of second users;

defining a queue for the plurality of second users;

allocating the help request to the first one of the plurality of second users in the queue; and

placing the allocated second user to an end of the queue after responding to the allocated help request.

In an embodiment, the method further comprising:

defining a first operating mode for the second user, wherein the second user not receiving help requests from first users;

defining a second operating mode for the second user, wherein the second user receiving help requests from first users; and

wherein the operating mode being selected by the second user.

In an embodiment, the method further comprising:

increasing the second user level in response to at least one positive feedback.

In an embodiment, the method further comprising:

decreasing the second user level in response to at least one negative feedback.

In an embodiment, the second user comprising indicia configured to indicate a measurement of the second user's helpfulness determining the helpfulness of at least one of the characters.

In an embodiment, determining the helpfulness of a character comprises determining if the character has provided help to another character.

In an embodiment, if the character has provided help to another character, the character's helpfulness increases.

In an embodiment, if the character has received help from another character, the method further comprises determining if the character has successfully completed a service parameter after receiving the help.

In an embodiment, the method further comprising:

providing a reward to a character whose helpfulness measurement is above a threshold.

In an embodiment, the virtual environment service includes a plurality of levels and the reward is access to a new level.

In an embodiment, the method further comprising:

providing a virtual item utilized by first users to post help requests.

In an embodiment, the method further comprising:

allocating the help request to a plurality of second users;

defining responses to the help request by the plurality of second users;

processing the responses and responding to the help request;

generating feedback by the first user in response to the responding; and

modifying the plurality of second users' levels based on the feedback.

In an embodiment, the method further comprising:

providing a third user, with a third user account associated with a third user level of the virtual environment service, the third user level being higher than the second user level.

In an embodiment, the second user level comprises a helper and the third user level comprises a guardian.

In an embodiment, the virtual environment service comprises at least one of the following:
a virtual online game;
a social network application;
an online auction service; and
a virtual community service.

According to a second example aspect of the invention there is provided an apparatus comprising:

at least one processor; and

at least one memory including computer program code; the at least one memory and the computer program code configured to, with the at least one processor, cause the apparatus to:

provide a virtual environment service, wherein a plurality of characters interacting with each other;

provide a first user, with a first user account associated with a first user level of the virtual environment service;

provide a second user, with a second user account associated with a second user level of the virtual environment service, the second user level being higher than the first user level;

define a help request relating to the virtual environment service, by the first user;

allocate the help request to the second user;

respond to the help request by the second user;

generate feedback by the first user in response to the responding; and

modify the second user level based on the feedback.

According to a third example aspect of the invention there is provided a computer program embodied on a computer readable medium comprising computer executable program code, which code, when executed by at least one processor of an apparatus, causes the apparatus to:

provide a virtual environment service, wherein a plurality of characters interacting with each other;

provide a first user, with a first user account associated with a first user level of the virtual environment service;

provide a second user, with a second user account associated with a second user level of the virtual environment service, the second user level being higher than the first user level;

define a help request relating to the virtual environment service, by the first user;

allocate the help request to the second user;

respond to the help request by the second user;

generate feedback by the first user in response to the responding; and

modify the second user level based on the feedback.

According to a fourth example aspect of the invention there is provided a system comprising:

a server apparatus configured to:
provide a virtual environment service, wherein a plurality of characters interacting with each other;
provide a first user, with a first user account associated with a first user level of the virtual environment service;
provide a second user, with a second user account associated with a second user level of the virtual environment service, the second user level being higher than the first user level;
allocate a help request to the second user; and
modify the second user level based on feedback;

a first user apparatus configured to:
define the help request relating to the virtual environment service, by the first user; and
generate the feedback by the first user in response to responding; and

a second user apparatus configured to:
respond to the help request by the second user.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows a schematic picture of a system according to an example embodiment of the invention;

FIG. 2 presents an example block diagram of a user apparatus in which various embodiments of the invention may be applied;

FIG. 3 presents an example block diagram of user levels of a virtual environment service in which various embodiments of the invention may be applied;

FIG. 4 presents an example block diagram of a server apparatus in which various embodiments of the invention may be applied;

FIG. 5 presents an example block diagram of a computer apparatus in which various embodiments of the invention may be applied;

FIG. 6 shows a flow diagram showing operations in accordance with an example embodiment of the invention; and

FIG. 7 shows a flow diagram showing bully reporting in accordance with an example embodiment of the invention.

### DETAILED DESCRIPTION

In the following description, like numbers denote like elements.

in an embodiment, virtual environment service may comprise a service that is connected using either a network of a service central server and at least two service apparatuses or a peer-to-peer network of at least two service apparatuses. Users may create characters that may interact with each other in a virtual environment provided by the service that is stored on the service central server and the service apparatuses.

A beginner user may mean a player that is on a learning curve in the virtual environment service, for example, and does not know much service features yet. Such user may require help of an expert to complete a service parameter or achievement.

An experienced user may mean a user that has played some time the virtual environment service, for example, and does know many service features. Such user may provide help for a beginner user to complete a service parameter or achievement.

In an embodiment, a user may register an account with a service central server or within a peer-to-peer network and create characters that can interact with other characters in a virtual service environment. The player account may mean an account on the service central server or within a peer-to-peer network that contains a player profile including personal, billing, and character account information, such as user level in the virtual service environment.

In an embodiment, a first user level may correspond to a beginner user that is not able to provide help to other users but requests help from others. A second user level may correspond to an experienced user that is able to provide help to other users. The second user level may comprise a plurality of user levels that may help the first user level. Thus, a second, a third, a fourth and a fifth user level may be included, and so on.

In an embodiment, a higher level user may help a lower level user but no other way around.

In an embodiment, the virtual environment service may comprise at least one of the following: a virtual game, a social network application, an online auction service and a virtual community service.

Second level users, the helpers, may be by default off-duty, but when they would like to help other users they can decide to set themselves as on-duty in the service settings. When on-duty, the helper may be put to the end of a helper queue. The helper has to wait until other helpers on the queue have received their help request. After handling a received help request, the helper is returned to the end of the queue.

The helpers may be rewarded for their work as helping other users. Rewarding may assist helpers to progress on a helper talent track. The helper talent track may provide a career kind of playing mode integrated to the virtual environment service. To proceed in the talent track, certain achievement needs to be reached in the virtual environment service. For example, the talent track may start with basics of the environment topics, followed by learning to use helper tools as a help requester. The requester has to both create help requests and ask for a virtual environment tour. Next, the helper has to pass a quiz of the rules of the virtual environment society, for example.

In an embodiment, helper groups may be defined and the helper may join a helper group. In the beginning, all helpers may belong to a same group, but further on talent track helpers unlock possibility to create their own groups. After joining the group, the helper unlocks the helper tool and may start to be on-duty for receiving help requests.

In an embodiment, the helper may receive feedback for the help provided. A main feedback loop of the helper talent track may be a helper recommendation. After receiving help, the help requester may be asked “Would you recommend this helper to other users?”. These recommendations may be the core of the helper program. The recommendations may be used as one of the level requirements but may also be used for biasing the helper queue towards better helpers. This should provide a feature that the helpers who receive recommendations more often will also get more help requests. Helpers who receive fewer recommendations will be getting fewer requests and may thus eventually stop using the help tool. Such feature helps to automatically moderate the quality of the helper program.

In an embodiment, so-called guardians may be defined. The guardians are high-level helpers who are given more responsibility. For example, there may be a separate help request for bullying. When a user reports a bully, a number of random guardians will get the request to vote whether the report was valid or not. The guardians may see anonym chat history of the virtual environment room where the request was made, for example. In response to that, the guardians may vote if the issue was invalid, valid or severe. On invalid cases, the reporter is notified not to send false reports and may be punished. If majority of the guardians vote valid, the reported bully may be punished. On severe reports, the reported bully may be punished and reported to moderators of the virtual environment service for further review.

Help requests, helper tools, helper groups and helper talent track features improves the usability of the service for the beginners and enable a career mode and further challenges to more experienced users. Thus, the community of the virtual provides helping itself.

In an embodiment, a help request may be defined by a user of the service. The help request may be defined using a graphical user interface of an apparatus used by the user for using the service. A virtual item presented on the graphical user interface may be utilized by the user to trigger the help request. The virtual item may also comprise a help request menu item found from a menu structure of the service.

In an embodiment, user progress, positive actions and behavior towards the community may unlock them new tools and powers to further help in their work for the community and ultimate fame. Everyone can start to pursue a career in talent track, but to progress to higher levels one needs to be active, do tasks and get positive feedback from other users in the community. Participant pool renews automatically, and feedback loop ensures quality in the program.

In an embodiment, a use case for a help requester may be as follows. First a user logs in to the virtual environment service using the user account with a certain user level, for example a first user level if being a beginner user. As the user needs help, he/she may ask help via a help button from a context menu of the virtual environment room, for example. When using the help button the user may be given a text field to describe the issue. After sending the help request and before being accepted, the user may cancel the help request at any time. After a helper has accepted the help request, the help requester may at any point decide that he/she does not need help anymore. Afterwards the help requester may be given an option to e.g. thumb up the helper (“I would recommend the helper to guide other users”) or decide that the helper cannot be recommended. In case the help requester regards that the guide was hostile he/she can report the guide to moderators.

In an embodiment, a use case for a helper may be as follows. First a user logs in to the virtual environment service using the user account with a certain user level, for example a second or a third user level if being a helper. The helper may decide when to be on duty by toggling the state from the helper tool of the service, for example. When being on duty, the helper is given help requests that they can accept or decide not react to. Not reacting to the help request may cause a small penalty in the career mode. There may be no reject button as such would open up possibility to various problems (e.g. trying to reject issues until finding specific issues by a friend or trying to gain advance by finding issues by certain). When the helper has accepted a help request, he/she has an option to send an instant message to the user who is requesting help or to go to a same room or a virtual place in the virtual environment service. The helper may create a call for a help ticket to service moderators if the help case is severe. When helping new users, the helper may launch a tour where beginners automatically follow the helper to other rooms of the society as long as the tour lasts. Both users still have the ability to end the tour.

In an embodiment, users may start a talent path as soon as they unlock some basic elements or achievements, such as certain account age, activity, etc. Such unlocking may correspond to the progress of the user level from the first level to the second level. After that, the user may start processing talent-specific tasks. Leveling up will unlock new skills and tools needed to progress further. Tasks and activity needed to progress will benefit the community (welcoming new users, answering questions about the service, solving conflict situations, and improving the virtual environment service, for example.

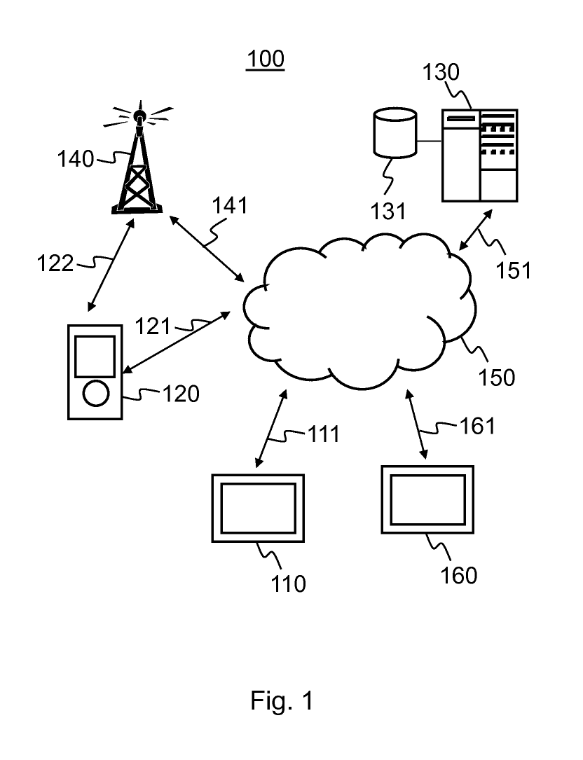

FIG. 1 shows a schematic picture of a system 100 according to an example embodiment of the invention.

A user apparatus 110, 120, 160 may comprise a mobile phone, an internet tablet, a mobile terminal or a laptop computer, for example. The user apparatus 110, 120, 160 is capable of downloading and locally executing software program code. The software program code may be a client application of a service whose server application is running on the server apparatus 130 of the system 100. The user apparatus 120 is configured to be connectable to a wireless communication network 140 over a wireless connection 122. The wireless connection 122 may comprise a mobile cellular network or a wireless local area network (WLAN), for example. The wireless communication network may be to a public data communication network 150, for example the Internet, over a data connection 141. The user apparatus 120 may be connected to the public data communication network 150 over a data connection 121 that may comprise a local area network (LAN) or a wireless area network (WLAN), for example.

In an embodiment, the system 100 comprises the user apparatus such as a computer apparatus 110, 160 configured to be connected to a public data communication network 150, for example the Internet, over a data connection 111, 161.

In an embodiment, the system 100 comprises a server apparatus 130, which comprises a storage device 131 for storing virtual environment service data and user data. Such data may be transferred over a data connection 151.

In an embodiment, a proprietary application in the user apparatus 110, 120, 160 may be a client application of a service whose server application is running on the server apparatus 130 of the system 100. The proprietary application may capture user activity and feedback, as well as provide user interface data for the service.

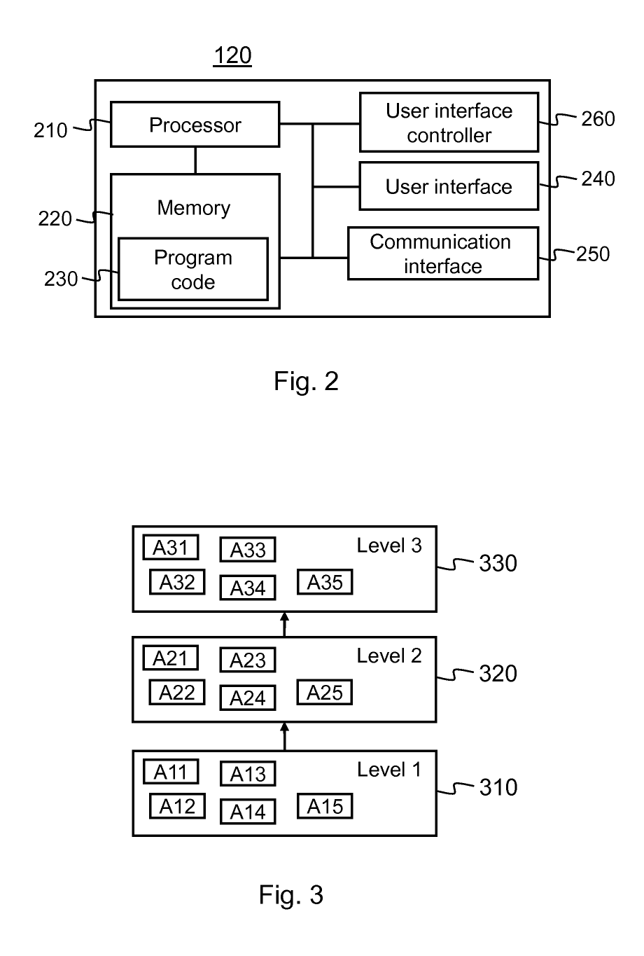

FIG. 2 presents an example block diagram of a user apparatus 120 in which various embodiments of the invention may be applied. The user apparatus 120 may be a user equipment (UE), user device or apparatus, such as a mobile terminal, a smart phone or other communication device.

The general structure of the user apparatus 120 comprises a user interface 240, a communication interface 250, a processor 210, and a memory 220 coupled to the processor 210. The user apparatus 120 further comprises software 230 stored in the memory 220 and operable to be loaded into and executed in the processor 210. The software 230 may comprise one or more software modules and can be in the form of a computer program product. The user apparatus 210 may further comprise a user interface controller 260.

The processor 210 may be, e.g., a central processing unit (CPU), a microprocessor, a digital signal processor (DSP), a graphics processing unit, or the like. FIG. 2 shows one processor 210, but the user apparatus 120 may comprise a plurality of processors.

The memory 220 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The user apparatus 120 may comprise a plurality of memories. The memory 220 may be constructed as a part of the user apparatus 120 or it may be inserted into a slot, port, or the like of the user apparatus 120 by a user. The memory 220 may serve the sole purpose of storing data, or it may be constructed as a part of an apparatus serving other purposes, such as processing data. A proprietary virtual environment service application and service data may be stored to the memory 220.

The user interface controller 280 may comprise circuitry for receiving input from a user of the user apparatus 120, e.g., via a keyboard, graphical user interface shown on the display of the user interfaces 240 of the user apparatus 120, speech recognition circuitry, or an accessory device, such as a headset, and for providing output to the user via, e.g., a graphical user interface or a loudspeaker.

The communication interface module 250 implements at least part of data transmission. The communication interface module 250 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB) for example. The communication interface module 250 may be integrated into the user apparatus 120, or into an adapter, card or the like that may be inserted into a suitable slot or port of the user apparatus 120. The communication interface module 250 may support one radio interface technology or a plurality of technologies. The user apparatus 120 may comprise a plurality of communication interface modules 250.

A skilled person appreciates that in addition to the elements shown in FIG. 2, the user apparatus 120 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the user apparatus 120 may comprise a disposable or rechargeable battery (not shown) for powering when external power if external power supply is not available.

In an embodiment, the user apparatus 120 comprises speech recognition means. Using these means, a pre-defined phrase may be recognized from the speech and translated into control information for the apparatus 120, for example.

FIG. 3 presents an example block diagram of user levels of a virtual environment service in which various embodiments of the invention may be applied. A user may start the service by creating an account and the system may provide the beginning user a first user level 310. After using the service and performing certain activities A11-A15 the user may progress to a second user level 320. The second user level may comprise the helper level. There again, after performing certain activities A21-A25 the user may progress to a third user level 330. The third level may comprise the guardian level. After performing certain activities A31-A35 the user may progress to a further user level or gain incentives, for example. The activities A11-A15, A21-A25, A31-A35 may comprise, for example, at least one of the following:
spending certain amount of time in the virtual environment of the service;
having an account valid for the service for a certain period of time;
respond to certain amount of help requests;
gain certain level of positive feedback; and
give certain number of guide tours in the virtual environment.

In an embodiment, there may at least two user levels, wherein the higher user level may help the lower user level.

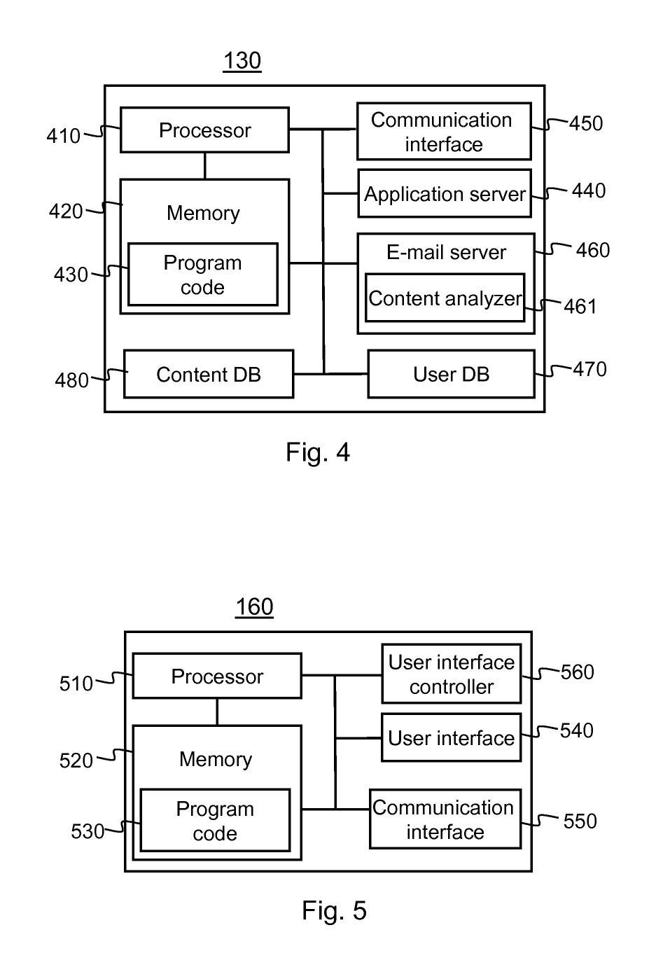

FIG. 4 presents an example block diagram of a server apparatus 130 in which various embodiments of the invention may be applied.

The general structure of the server apparatus 130 comprises a processor 410, and a memory 420 coupled to the processor 410. The server apparatus 130 further comprises software 430 stored in the memory 420 and operable to be loaded into and executed in the processor 410. The software 430 may comprise one or more software modules and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 130 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The server apparatus 130 may comprise a plurality of memories. The memory 420 may be constructed as a part of the server apparatus 130 or it may be inserted into a slot, port, or the like of the server apparatus 130 by a user. The memory 420 may serve the sole purpose of storing data, or it may be constructed as a part of an apparatus serving other purposes, such as processing data.

The communication interface module 450 implements at least part of radio transmission. The communication interface module 450 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 450 may be integrated into the server apparatus 130, or into an adapter, card or the like that may be inserted into a suitable slot or port of the server apparatus 130. The communication interface module 450 may support one radio interface technology or a plurality of technologies. Captured activity data associated with environmental data of the user apparatus 120 may be received by the server apparatus 130 using the communication interface 450.

The e-mail server process 460, which receives e-mail messages sent from user apparatuses 120 and computer apparatuses 160 via the network 150. The server 460 may comprise a content analyzer module 461, which checks if the content of the received message meets the criteria that are set for new activity data item of the service. The content analyzer module 461 may for example check whether the e-mail message contains a valid data item to be used as virtual environment service data item. The valid service data item received by the e-mail server is then sent to an application server 440, which provides application services e.g. relating to the user accounts stored in a user database 470 and content of the content management service. Content provided by the service system 100 is stored in a content database 480.

A skilled person appreciates that in addition to the elements shown in FIG. 4, the server apparatus 130 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

FIG. 5 presents an example block diagram of a computer apparatus 110,160 in which various embodiments of the invention may be applied. The computer apparatus 110,160 may be a user equipment (UE), user device or apparatus, such as a mobile terminal, a smart phone, a laptop computer, a desktop computer or other communication device.

The general structure of the computer apparatus 110,160 comprises a user interface 540, a communication interface 550, a processor 510, and a memory 520 coupled to the processor 510. The computer apparatus 110,160 further comprises software 530 stored in the memory 520 and operable to be loaded into and executed in the processor 510. The software 530 may comprise one or more software modules and can be in the form of a computer program product. The computer apparatus 160 may further comprise a user interface controller 560.

The processor 510 may be, e.g., a central processing unit (CPU), a microprocessor, a digital signal processor (DSP), a graphics processing unit, or the like. FIG. 5 shows one processor 510, but the computer apparatus 160 may comprise a plurality of processors.

The memory 520 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The computer apparatus 160 may comprise a plurality of memories. The memory 520 may be constructed as a part of the computer apparatus 110, 160 or it may be inserted into a slot, port, or the like of the computer apparatus 110, 160 by a user. The memory 520 may serve the sole purpose of storing data, or it may be constructed as a part of an apparatus serving other purposes, such as processing data.

The user interface controller 560 may comprise circuitry for receiving input from a user of the computer apparatus 110, 160, e.g., via a keyboard, graphical user interface shown on the display of the user interfaces 240 of the computer apparatus 110, 160, speech recognition circuitry, or an accessory device, such as a headset, and for providing output to the user via, e.g., a graphical user interface or a loudspeaker.

The communication interface module 550 implements at least part of radio transmission. The communication interface module 550 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 550 may be integrated into the computer apparatus 110, 160, or into an adapter, card or the like that may be inserted into a suitable slot or port of the computer apparatus 110, 160. The communication interface module 550 may support one radio interface technology or a plurality of technologies. The computer apparatus 110, 160 may comprise a plurality of communication interface modules 550. Service data items may be downloaded from the server apparatus 130 and stored to the computer apparatus 110, 160.

A skilled person appreciates that in addition to the elements shown in FIG. 5, the computer apparatus 110, 160 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the computer apparatus 110, 160 may comprise a disposable or rechargeable battery (not shown) for powering when external power if external power supply is not available.

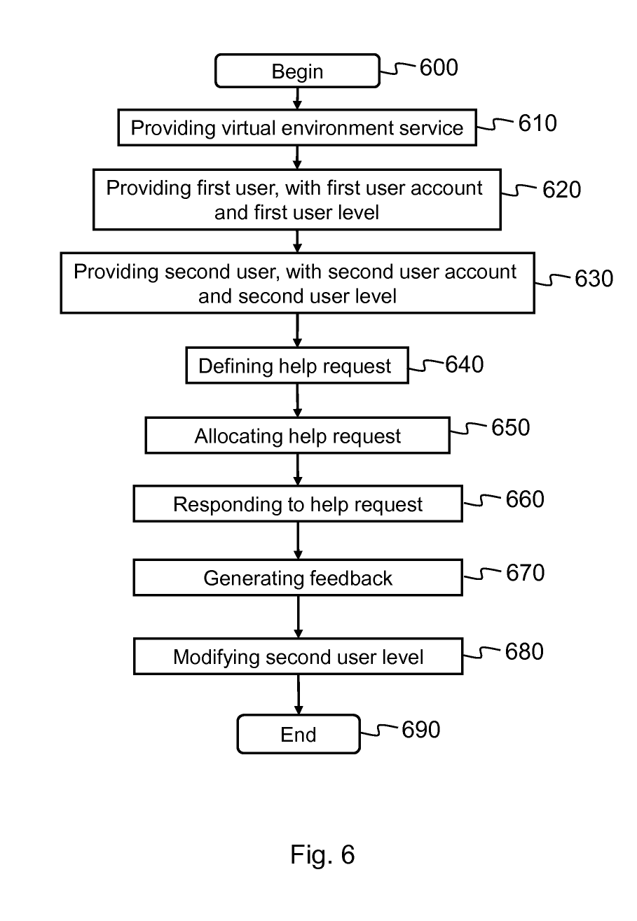

FIG. 6 shows a flow diagram showing operations in accordance with an example embodiment of the invention. In step 600, the method is started. In step 610, a virtual environment service is provided, wherein a plurality of characters interacting with each other. In step 620, a first user is provided, with a first user account associated with a first user level of the virtual environment service. In step 630, a second user is provided, with a second user account associated with a second user level of the virtual environment service, the second user level being higher than the first user level. In step 640, a help request is defined relating to the virtual environment service, by the first user. In step 650, the help request is allocated to the second user. In step 660, the help request is responded by the second user. In step 670, feedback is generated by the first user in response to the responding. In step 680, the second user level is modified based on the feedback. The method is ended in step 690.

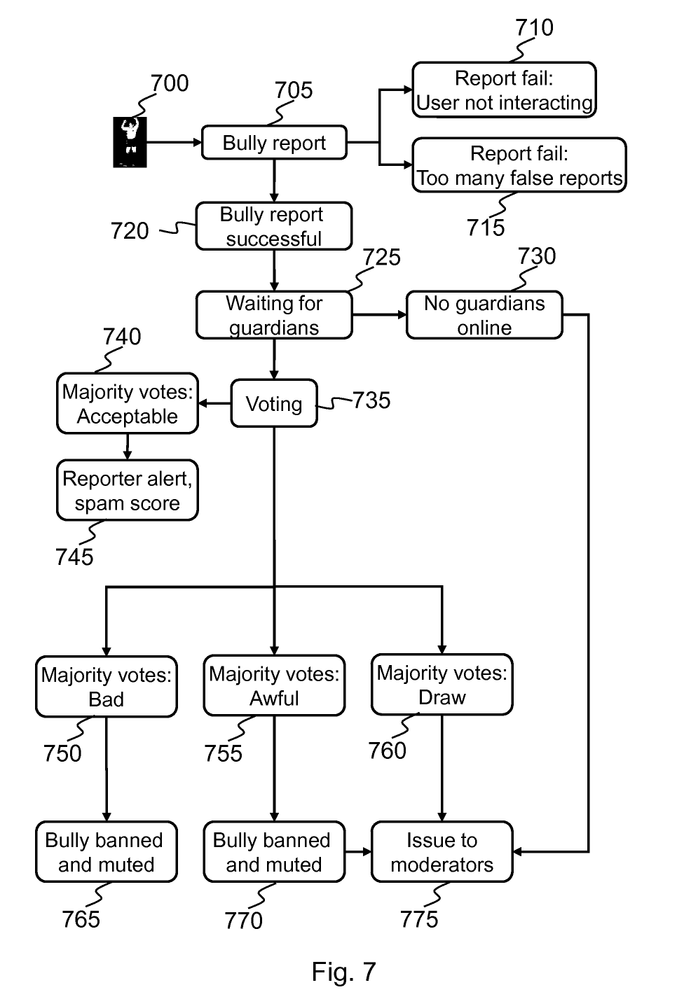

FIG. 7 shows a flow diagram showing bully reporting in accordance with an example embodiment. A user 700 may send a bully report 705. The received bully report 705 is checked before further processing. In case the suspected bully being reported has not interacted in the virtual environment service at all, the report is failed in phase 710. In case the reporting user has too many false bully reports in the virtual environment service, the report is failed in phase 715. Otherwise, the bully report proceeds as successful in phase 720.

In an embodiment, a number of guardians are being waited for in phase 725, to solve the bully report issue. In case there are no guardians available online within a certain time threshold in phase 730, the bully report may be transferred to moderators of the service.

In an embodiment, when required number of guardians is available, voting may take place in phase 735. In case the suspected bully is voted behaving acceptably in phase 740, the bully reporter 700 will be alerted and a spam score of the user 700 may be increased in phase 745. Such spam score may be used for example in phase 715 for evaluation of the next report from the same user.

In an embodiment, if the suspected bully is voted behaving unacceptably, one of the following phases may be triggered. In phase 750, if the majority of the guardians votes the suspected bully behaved badly, the bully may be banned and muted in the virtual environment service for a first period of time, as illustrated by phase 765. In phase 755, if the majority of the guardians votes the suspected bully behaved awfully, the bully may be banned and muted in the virtual environment service for a second period of time, as illustrated by phase 770, and the issue may be forwarded to moderators. In phase 760, if the voting results to draw, as illustrated by phase 760, the issue may be forwarded to moderators in phase 775.

In an embodiment, a server computer or centralized authority may not be necessary. For example, the present invention may, in an embodiment, be practiced on one or more devices without a central authority. In such an embodiment, any functions described herein as performed by the server computer or data described as stored on the server computer may instead be performed by or stored on one or more such devices.

In an embodiment, players may improve their progression in the virtual environment service through helping other user characters.

In an embodiment, amount and quality of help a given user's character has provided to other user characters is a measured in a service. A character's helpfulness may be measured using any suitable method including the outcome of the help provided and the feedback of the helped user.

As non-limiting examples, assistance may be given in the form of written notes (e.g. emails or instant messages including a text-based or other form of an answer or hint); lending or giving a virtual object that solves or helps to solve a problem or otherwise aids the help requester in completing a task.

Various embodiments have been presented. It should be appreciated that in this document, words comprise, include and contain are each used as open-ended expressions with no intended exclusivity. If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A method comprising:
providing a virtual environment service, wherein a plurality of characters interacting with each other;
providing a first user, with a first user account associated with a first user level of the virtual environment service;
providing a second user, with a second user account associated with a second user level of the virtual environment service, the second user level being higher than the first user level;
defining a help request relating to the virtual environment service, by the first user;
allocating the help request to the second user;
responding to the help request by the second user;
generating feedback by the first user in response to the responding; and
modifying the second user level based on the feedback.

2. The method of claim 1, further comprising:
providing a plurality of second users;
defining a queue for the plurality of second users;
allocating the help request to the first one of the plurality of second users in the queue; and
placing the allocated second user to an end of the queue after responding to the allocated help request.

3. The method of claim 1, further comprising:
defining a first operating mode for the second user, wherein the second user not receiving help requests from first users;
defining a second operating mode for the second user, wherein the second user receiving help requests from first users; and
wherein the operating mode being selected by the second user.

4. The method of claim 1, further comprising:
increasing the second user level in response to at least one positive feedback.

5. The method of claim 1, further comprising:
decreasing the second user level in response to at least one negative feedback.

6. The method of claim 1, wherein the second user comprising indicia configured to indicate a measurement of the second user's helpfulness determining the helpfulness of at least one of the characters.

7. The method of claim 6, wherein determining the helpfulness of a character comprises determining if the character has provided help to another character.

8. The method of claim 7, wherein if the character has provided help to another character, the character's helpfulness increases.

9. The method of claim 7 wherein, if the character has received help from another character, the method further comprises determining if the character has successfully completed a service parameter after receiving the help.

10. The method of claim 6 further comprising, providing a reward to a character whose helpfulness measurement is above a threshold.

11. The method of claim 10, wherein the virtual environment service includes a plurality of levels and the reward is access to a new level.

12. The method of claim 1 further comprising providing a virtual item utilized by the first user to post help requests.

13. The method of claim 1 further comprising:
allocating the help request to a plurality of second users;
defining responses to the help request by the plurality of second users;
processing the responses and responding to the help request;
generating feedback by the first user in response to the responding; and
modifying the plurality of second users' levels based on the feedback.

14. The method of claim 1 further comprising:
providing a third user, with a third user account associated with a third user level of the virtual environment service, the third user level being higher than the second user level.

15. The method of claim 14, wherein the second user level comprises a helper and the third user level comprises a guardian.

16. The method of claim 1, wherein the virtual environment service comprises at least one of the following:
a virtual online game;
a social network application;
an online auction service; and
a virtual community service.

17. An apparatus comprising:
at least one processor; and
at least one memory including computer program code; the at least one memory and the computer program code configured to, with the at least one processor, cause the apparatus to:
provide a virtual environment service, wherein a plurality of characters interacting with each other;
provide a first user, with a first user account associated with a first user level of the virtual environment service;
provide a second user, with a second user account associated with a second user level of the virtual environment service, the second user level being higher than the first user level;
define a help request relating to the virtual environment service, by the first user;
allocate the help request to the second user;
respond to the help request by the second user;
generate feedback by the first user in response to the responding; and
modify the second user level based on the feedback.

18. A computer program embodied on a computer readable medium comprising computer executable program code, which code, when executed by at least one processor of an apparatus, causes the apparatus to:
provide a virtual environment service, wherein a plurality of characters interacting with each other;
provide a first user, with a first user account associated with a first user level of the virtual environment service;
provide a second user, with a second user account associated with a second user level of the virtual environment service, the second user level being higher than the first user level;
define a help request relating to the virtual environment service, by the first user;
allocate the help request to the second user;
respond to the help request by the second user;
generate feedback by the first user in response to the responding; and
modify the second user level based on the feedback.

19. A system comprising:
a server apparatus configured to:
provide a virtual environment service, wherein a plurality of characters interacting with each other;
provide a first user, with a first user account associated with a first user level of the virtual environment service;
provide a second user, with a second user account associated with a second user level of the virtual environment service, the second user level being higher than the first user level;
allocate a help request to the second user; and
modify the second user level based on feedback;
a first user apparatus configured to:
define the help request relating to the virtual environment service, by the first user; and
generate the feedback by the first user in response to responding; and
a second user apparatus configured to:
respond to the help request by the second user.
